(19) United States
(12) Patent Application Publication
(10) Pub. No.: US 2025/0054078 A1
(43) Pub. Date: Feb. 13, 2025

(54) MACHINE SCHEDULE GENERATION METHOD AND SYSTEM

(71) Applicant: FLEXCITON LIMITED, London (GB)

(72) Inventors: Dionysios XENOS, London (GB); Ioannis KONSTANTELOS, London (GB); Robert MOSS, London (GB); Ruaridh WILLIAMSON, London (GB)

(21) Appl. No.: 18/720,318

(22) PCT Filed: Dec. 9, 2022
(86) PCT No.: PCT/GB2022/053164

§ 371 Date: Jun. 14, 2024

(30) Foreign Application Priority Data
Dec. 14, 2021 (GB) 2118121.9

(51) Int. Cl. G06Q 50/04; G06Q 10/0631

(52) U.S. Cl. CPC G06Q 50/04; G06Q 10/06314

(57) ABSTRACT

A method and system for generating a schedule of tasks for a group of machines to perform in a factory. The method and system are particularly applicable in semiconductor manufacturing in manufacturing semiconductor wafers. A first method is used to generate a schedule for the group of machines comprising allocating one task or a time-ordered list of several tasks to each machine in a group of machines. The schedule is then optimised using a second method.

### FIELD

The present invention relates to a system and method for generating a schedule for a group of machines in a factory. In particular, the present invention relates to semiconductor wafer manufacturing.

### BACKGROUND

In complex manufacturing settings, such as semiconductor wafer fabrication plants, machines are used in specific orders to output a variety of different semiconductor products from the fabrication plants. A single semiconductor wafer may have over 1,000 manufacturing steps performed on it in different work areas of the factory during its production.

Currently, each of the machines in the factory is provided with a schedule of tasks that the machine is required to perform.

Pre-determined workflows for each type of output product are used to send tasks to each relevant machine in the fabrication plant.

Each machine receives these tasks as they are generated, along with various metadata about each task and, using a set of pre-determined rules, orders the current list of tasks to be performed using these pre-determined rules.

However, the predetermined rules schedule the production of the products in a suboptimal manner, resulting in a reduced performance in manufacturing the products, such as low velocity, long cycle times and low number of wafer moves per unit of time. The pre-determined rules often ineffectively prioritise the tasks at each machine, resulting in partially manufactured complex items not being completed within the required period of time and becoming damaged (for example by oxidising having been left exposed to air for too long).

The present Invention aims to improve the scheduling of production tasks and relevant manufacturing resources in the factory.

### SUMMARY OF INVENTION

The present invention provides a system for providing a schedule for a group of machines in a factory, the system comprising a computer system for generating the schedule for the group of machines, and a communication means for providing the schedule to the group of machines in the factory, wherein the computer system is configured to generate the schedule for the group of machines by performing the steps of: receiving a plurality of tasks to be performed by the group of machines; using a first method to generate the schedule for the group of machines, comprising allocating one task of the plurality of tasks or a time-ordered list of some of the plurality of tasks to each machine of the group of machines; and using a second method to optimise the schedule generated by the first method; and wherein the computer system is further configured to provide the schedule for the group of machines to the group of machines in the factory via the communication means.

The group of machines does not include all of the machines in the factory. The group of machines is a smaller sub-set of the machines in the factory which are used in manufacturing products. For example, the total number of machines in a factory or wafer fabrication site could be between 30 to 10,000. In a typical mid-size factory the total number of machines is about 800. In giga semi factories, the total number of machines could be 1,000to 5,000 per building, with the site consisting of several buildings which define a semiconductor fab/facility. The number of machines in the group of machines could be, for example, 3 to 100.There may be, for example, about 10 to 15 machines in a group of machines.

Having the second method optimise a schedule for the group of machines which has already been prepared by a first method advantageously results in an effective schedule for the group of machines.

Further optional features of the invention are defined in the appended dependent claims.

The present invention further provides a computer-implemented method of providing a schedule for a group of machines, the method comprising generating the schedule for the group of machines by performing the steps of: receiving a plurality of tasks to be performed by the group of machines; using a first method to generate the schedule for the group of machines, comprising allocating one task of the plurality of tasks or a time-ordered list of some of the plurality of tasks to each machine of the group of machines; and using a second method to optimise the schedule generated by the first method, and wherein the method further comprises providing the schedule for the group of machines to the group of machines in a factory.

The computer-implemented method may comprise the steps performed by the computer system. For the sake of completeness, the computer-implemented method may comprise the steps described herein.

The computer-implemented method may perform a filtering step after using the first method to generate the schedule, wherein the filtering step comprises generating a filtered schedule by removing at least one of the plurality of tasks from the schedule generated by the first method, and wherein using the second method to optimise the schedule generated by the first method comprises optimising the filtered schedule.

Removing at least one of the plurality of tasks from the schedule generated by the first method may comprise removing any of the plurality of tasks which are scheduled to begin beyond a predetermined time limit.

Tasks which are scheduled to begin before the predetermined time limit are expected to be executed with higher accuracy compared to tasks which are scheduled to begin after the predetermined time limit which are subject to higher uncertainty (as, the further one looks ahead, the higher the errors in transition/processing times and the higher the probabilities for machines to fail in executing their schedules).

After using the second method to optimise the schedule, the computer-implemented method may further amend the schedule to include at least one or all of the tasks that were removed from the schedule during the filtering step.

The computer-implemented method may further comprise receiving data from the factory. The method may generate the schedule for the group of machines using the data from the factory. The data from the factory may convey or comprise the plurality of tasks to be performed by the group of machines.

The data may be received from the factory multiple times at a first frequency. Each time the data is received the data at the first frequency, the computer-implemented method may generate the schedule for the group of machines using the data received at the first frequency, and provide the schedule to the group of machines.

Generating the schedule for the group of machines using the data received at the first frequency may comprise using the data received at the first frequency in the first method to generate the schedule and/or in the second method to optimise the schedule.

The computer-implemented method may further comprise receiving updated data from the factory multiple times at a second frequency, and optionally wherein the second frequency is higher than the first frequency.

The computer-implemented method may further comprise the steps of generating an adjusted schedule for the group of machines by using the updated data to adjust a previous schedule that was generated for the group of machines using the data received at the first frequency, and to providing the adjusted schedule to the group of machines.

Using the data to adjust the previous schedule may comprise an iterative process, wherein each time that the updated data is received at the second frequency, the updated data is used to update the adjusted schedule.

The updated data may comprise at least one additional task to be performed by the group of machines, and wherein adjusting the previous schedule comprises amending the previous schedule to include the at least one additional task.

The data from the factory and/or the updated data may comprise one or any combination of: a location of each product of on which the plurality of tasks are to be performed; a location or locations of additional resources required by the group of machines to perform the plurality of tasks; a location or locations of one or more containers in which additional resources required by the group of machines to perform the plurality of tasks is contained; a transit time to transfer one or more of the products on which the plurality of tasks are to be performed to the group of machines using, for example, an Automated Material Handling System (AMHS); a transit time to transfer one or more of the additional resources that are required by the group of machines to perform the plurality of tasks to the group of machines using, for example, an AMHS; an operational status of one or more machines in the group of machines; a priority of each product or task; preferences of which machines to use per product per process step and recipe of the machines; which recipes are active in each machine; maximum volume of products to be processed in a machine or in a zone of process steps.

The computer-implemented method may further perform the step of generating a schedule for additional resources required by the group of machines to perform the plurality of tasks, wherein generating the schedule for additional resources comprises allocating the additional resources to one or more machines in the group of machines so that the group of machines can operate in accordance with the schedule for the group of machines. The method may further comprise providing the schedule of additional resources to the factory.

The computer-implemented method may further perform the step of generating a schedule for an Automated Material Handling System (AMHS) in the factory, wherein generating the schedule for the AMHS comprises determining instructions for the AMHS to move one or more products on which the plurality of tasks are to be performed and/or to move additional resources required by the group of machines to perform the plurality of tasks, so that the group of machines can operate in accordance with the schedule for the group of machines. The method may further comprise providing the schedule for the AMHS to the factory.

The group of machines may comprise only one type of machines. Alternatively, the group of machines may comprise two or more different types of machine, wherein the machines in the group of machines are coupled together by at least one operational constraint such as a time link constraint, a maximum number of products which can be operated on by the group of machines, a Kanban process flow constraint and/or a high degree of re-entrancy of products moving between the machines. The method or the system may comprise generating a schedule for two or more groups of machines, and providing the schedules for the groups of machines to the factory. One of the groups of machines may comprise only one type of machine and another of the groups of machines may comprise two or more different types of machine.

Providing the schedule for the group of machines to the group of machines may comprise displaying the schedule on one or more user interfaces in the factory. Alternatively or additionally, providing the schedule for the group of machines to the group of machines may comprise transmitting control signals. The control signals may be transmitted to the machines to automatically operate the machines in the group of machines in accordance with the schedule and/or the control signals may automatically operate processes in the factory to enable the machines to operate in accordance with the schedule for the group of machines. The method may further comprise automatically operating the machines in the group of machine in accordance with the schedule, for example by using the control signals to operate the machines. Additionally or alternatively, the method may further comprise automatically operating processes in the factory to enable the machines to operate in accordance with the schedule for the group of machines, for example by using the control signals to operate the processes.

Before using the first method to generate the schedule for the plurality of machines, the method may perform a clustering step in which the group of machines is divided into subgroups of machines, and wherein the method generates the schedule for one or more of the subgroups of machines, and provides the schedule for the one or more subgroups of machines to the factory.

The second method may be computationally more expensive than the first method.

The first method may comprise heuristic rules, dispatch rules, constraint programming or using a previously-generated schedule for the plurality of machines. The second method may comprise Mixed-Integer Linear Programming, constraint programming, an advanced heuristic method or a metaheuristic method.

The computer-implemented method may be performed in all or in part on one or more computers which are located remotely from the factory, for example in a cloud server.

The present invention further provides a computer software product for installing on a factory computer system for providing a schedule to a group of machines in a factory, wherein the computer software product enables the factory computer system to operate using the system or method described herein. The factory computer system is a computer system located at a factory or not located at a factory but associated with a factory in which the group of machines are located.

The factory may comprise a semiconductor wafer fabrication factory. Each task of the plurality of tasks may comprises a manufacturing step in manufacturing a semiconductor wafer. Optionally, the machines are operable to perform any or any combination of: wafer fabrication; semiconductor wafer fabrication; semiconductor manufacturing; computer chip manufacturing; automotive manufacturing; computer manufacturing; computer hard drive manufacturing; computer memory manufacturing; solar panel manufacturing; display manufacturing.

Optionally the method further comprises receiving any or any combination of: a state of the one or more related machines; an initial state of one or more resources; a state of a fabrication facility: one or more locations of any relevant products; a current task of one or more of the machines; an idle state of one or more of the machines; a maintenance state of one or more of the machines; a demand of one or more of the products; a priority of one or more products; specific due dates of one or more products.

Optionally, the machine is operable to manufacture any or any combination of: computer chips; computer memory; computer storage; semiconductors; wafers; hard drives; random access memory; solid state memory; storage chips; heads of hard drive disks.

Optionally, the machines comprise metrology equipment; furnace equipment; cleaning equipment; photolithography equipment.

The method of aspects and/or embodiments can be used across a wide variety of industries in which complex products are manufactured, or products that require a specific sequence of steps to be performed to output the finished product, or in settings where multiple different products are manufactured in parallel using at least some common facilities/machines/tools/resources such as biotech.

### BRIEF DESCRIPTION OF DRAWINGS

Embodiments will now be described, by way of example only and with reference to the accompanying drawings having like-reference numerals, in which:

FIG. 1 shows an example of a computer system according to an embodiment;

FIG. 2 shows an example of a computer system according to an embodiment;

FIG. 3 illustrates an example of some machines and products within the factory;

FIG. 4 shows an example of movement of a product between different machines in the factory;

FIG. 5 shows example time constraints for a single lot;

FIG. 6 shows a method of generating a schedule for a group of machines, according to an embodiment;

FIG. 7 shows an example of a provisional schedule generated for the group of machines;

FIG. 8 shows an example of the provisional schedule from FIG. 7 after it has been optimised;

FIG. 9 shows a method of generating a schedule for a group of machines according to a further embodiment;

FIG. 10 shows an example of a provisional schedule generated for the group of machines;

FIG. 11 shows an example of the provisional schedule from FIG. 10 after it has been filtered and optimised;

FIG. 12 shows an example of the filtered optimised schedule from FIG. 11, after the filtered tasks have been added back in to the schedule;

FIG. 13 shows an example of a method of generating a schedule for a group of machines according to a further embodiment;

FIG. 14 illustrates a sequence of schedules for the group of machines that are provided according to the example method of FIG. 13;

FIG. 15 is an example of a clustering process;

FIG. 16 illustrates generating a schedule for additional resources and/or for the Automated Material Handling System (AMHS) in the factory;

FIG. 17 is an example of a schedule generated for a machine in a group of machines, additional resources, and the AMHS; and

FIG. 18 is an example of an optimising method for a group of machines having multiple different types of machine.

### SPECIFIC DESCRIPTION

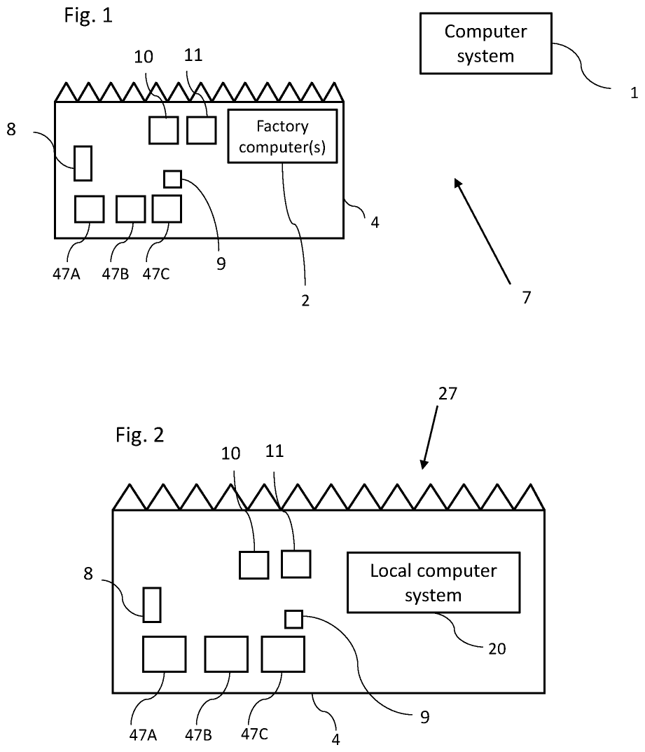

Referring to FIGS. 1 to 18, aspects of the invention will now be described with reference to each Figure in turn.

FIG. 1 shows an embodiment of a system 7 in accordance with the present invention. The system 7 comprises a computer system 1 for generating a schedule for a group of machines 47A, 47B, 47C in the factory 4. The computer system 1 comprises one or more computers. The schedule is a schedule for operating the machines.

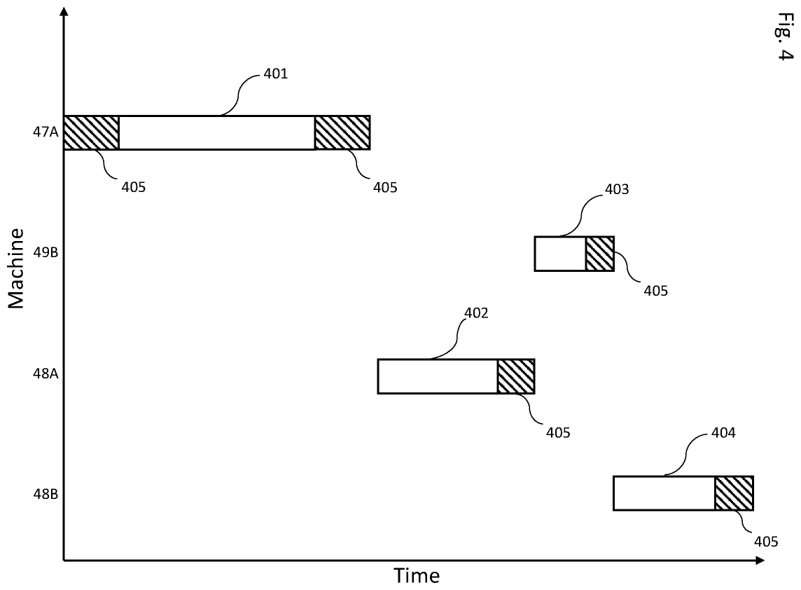

The factory 4 comprises machines 47A, 47C, 47C, for manufacturing products such as semiconductor wafers. The machines can be grouped into groups of machines, which is described in more detail in relation to FIG. 3.

The computer system 1 is configured to generate the schedule for the group of machines, according to the method described herein. Having generated the schedule for the group of machines, the computer system 1 then provides the schedule to the group of machines in the factory 4 via a communication means.

The communication means may comprise one or more user interfaces 8 in the factory. The user interface(s) 8 displays the schedule for the group of machines so that people working in the factory can operate the machines in accordance with the schedule. Alternatively or additionally, the communication means comprises means to transmit control signals 9, wherein the control signals automatically operate the machines in the group of machines in accordance with the schedule for the group of machines and/or wherein the control signals automatically operate processes in the factory to enable the machines to operate in accordance with the schedule for the group of machines. Automatically operating processes in the factory may, for example, involve moving products or resources in the factory, for example using robots or the AMHS, so that they are present at the machines at times required by the schedule for the group of machines.

The means to transmit control signals 9 may include, for example, a network connection from the computer system 1 to the machines 47A, 47B, 47C, and/or to robots in the factory or to the AMHS, which moves the products and additional resources around the factory. Alternatively, the means to transmit control signals 9 may include a factory computer(s) 2 which is in communication with the first computer system 1 and the machines 47A, 47B, 47C, and/or robots in the factory and/or the AMHS, such as via a wired or a wireless connection.

The computer system 1 may provide the schedule to the user interfaces 8 directly, for example via a network, or indirectly, such as via a computer or computers 2 located in the factory 2. The computer system 1 may be connected to the factory computer(s) 2 via a network. Similarly, the computer system 1 may provide the schedule to the means to transmit control signals 9 directly or indirectly via the factory computers 2.

The system may comprise a means for collecting data from the factory 10, and a means for sending the collected data to the computer system 11. The means for collecting data from the factory 10 and the means for sending the collected data to the computer system may be part of a Manufacturing Execution System (MES) or any other software system used to handle manufacturing data e.g. dispatching software.

The means for collecting data from the factory may include, for example RFID or bar code tagging of products and additional resources in the factory, or sensors in the factory to gather data about the products, machines or additional resources.

The means for sending the collected data to the computer system 11 may comprise one or more computers in communication with the means for collecting data from the factory 10, such as via a wired or wireless connection. The means for sending the collected data to the computer system 11 may be in communication with the computer system 1, for example via a network.

The means for sending the collected data to the computer system may send the data to the computer system 1 multiple times at a first frequency, and also at a second frequency which is higher than the second frequency. The first frequency may be, for example, 5minutes, and the second frequency may be, for example, 30 seconds or less. The data sent at the second frequency may be a subset of the data sent at the first frequency. Alternatively, the means for sending the collected data to the computer system 1 may send the data only at a single frequency.

The data which is collected and sent from the factory to the computer system is updated each time that it is sent to convey the most up to date data from the factory. The computer system 1 uses the data from the factory to generate the schedule for the group of machines.

The data collected from the factory by the means for collecting data 10 is described in more detail below in relation to FIG. 3. In the example shown in FIG. 1, the computer system 1 is located remotely from the factory 4, such as in a cloud. Alternatively, the computer system 1 may be located at the factory 4.

In an alternative embodiment, the method steps described herein in generating the schedule for the group of machines may be divided between the computer system 1 and the factory computer(s) 2 which are computers associated with the factory and which may be located at the factory.

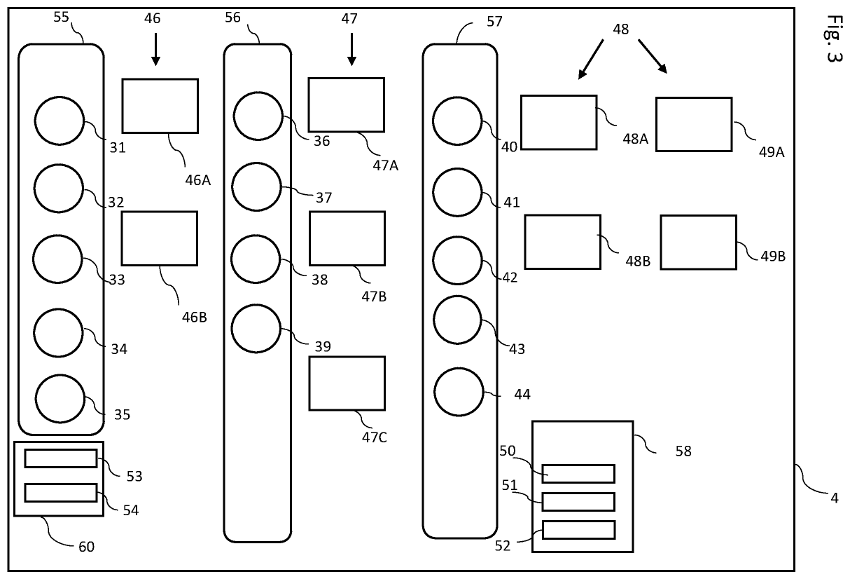

FIG. 2 shows an alternative embodiment of a system 27, in which the method steps described herein in generating the schedule for the group of machines are performed by a local computer system 20 located at the factory 4. The local computer system 20 comprises one or more computers. FIG. 2 also shows the machines 47A, 47B, 47C, the user interface(s) 8, the means to transmit control signals 9, the means for collecting data from the factory 10, and the means for sending the data to the computer system 11, which are described in more detail in relation to FIG. 1.

FIG. 3 illustrates some of the machines, products and resources that are located in the factory 4. The factory 4 may manufacture semiconductor devices. In reality the factory will have many more machines products and resources than are shown in FIG. 3. The products in the factory may be semiconductor wafers, 31, 32, 33, 34, 35, 36, 37, 38, 39, 40, 41, 42, 43, 44. The factory has different machines 46A, 46B, 47A, 47B, 47C, 48A, 48B, 49A, 49B, which are grouped into a first group of machines 46, a second group of machines 47 and a third group of machines 48, although it will be appreciated that the factory may just comprise one group of machines, or many more groups of machines. At least one or the groups of machines or all of the groups of machines may have a schedule generated for them in accordance with the method described herein. The machines perform tasks on the products 31, 32, 33, 34, 35, 36, 37, 38, 39, 40, 41, 42, 43, 44. Each task is a manufacturing step in manufacturing a product. Each product requires a sequence of tasks to be performed on it to manufacture the product. Some additional tasks in the factory may be performed by people working in the factory, such as a task of moving the products between the machines.

The products may be located on racks 55, 56, 57 while they wait for their next task to be performed. FIG. 3 shows products 31 to 35 located on a first rack 55 near the first group of machines 46, products 36 to 39 located on a second rack 56 near the second group of machines 47, and products 40 to 44 located on a third rack 57 near the third group of machines 48. There will also be an additional rack for products located near the machines 49A. 49B, although this rack is not shown in the figure. Although not shown in the figure, the products may also be transported around the factory to different locations within the factory using an Automated Machine Handling System (AMHS).

Depending on the task to be performed, a machine 46A, 46B, 47A, 47B, 47C, 48A, 48B, 49A, 49B, may require additional resources to carry out a particular task. For example, a photolithography machine may require a particular mask or reticle 50, 51, 52, 53, 54 to carry out a particular photolithography task. The additional resources may be located in storage in the factory, for example the reticles may be stored in reticle stockers, which are automated machines that store, clean and retrieve the reticles, or in reticle libraries 60, or they may be located at other locations in the factory such as in a container 58. The additional resources may be transported around the factory using the AMHS. The additional resources required to perform the tasks may also include chemical gases that are used, for example, in implantation, or gold which is required for some specific tasks.

The grouping of the machines will now be explained. In FIG. 3, the first group of machines 46 has a first machine 46A and a second machine 46B; and the second group of machines 47 has a first machine 47A, a second machine 47B, and a third machine 47C. Within a group of machines, the machines can all be the same type of machine, for example each machine 46A, 46B, in the first group of machines 46 is a furnace machine which heats the products.

Even if the machines in a group are all the same type of machine, they may be programmed with different recipes, for example one of the machines may be programmed to perform certain tasks on the products faster than other machines within the same group.

Variations in speed between the different machines may also occur depending on the maker of the machine and the cumulative operating hours of the machine. This means that there are reasons for choosing one machine over another for a particular task within the same group. This grouping of machines is effective when the machines are not involved in constraints that couple many sequential steps.

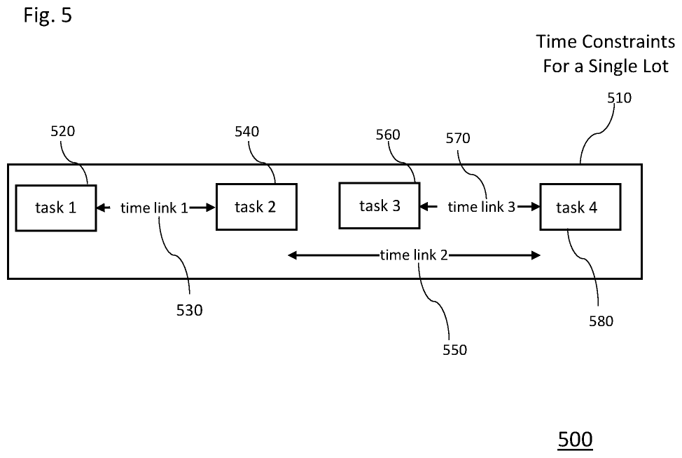

Alternatively, within a group of machines, the machines can be different types of machine with the machines in the group being coupled together by at least one operational constraint such as a time link constraint, discussed further below in relation to FIG. 5, a maximum number of products which can be operated on by the group of machines, a Kanban process flow constraint or where there is a high degree of re-entrancy between the machines in the group to perform successive tasks on a product. For example, a group of machines 48 includes a first machine 48A, a second machine 48B, a third machine 49A, and a fourth machine 49B. The first and second machines 48A, 48B may be cleaning machines, and the third and fourth machines 49A, 49B may be furnace machines but the schedule is produced for all of these machines together as a single group 48 since the machines 48A, 48B, 49A, 49B are linked through timelinks. The wafers must be cleaned first using the a cleaning machine 48A, 48B, and then they need to be moved quickly to a furnace machine 49A, 49B before they are oxidised.

As described above, the system may comprise a means for collecting data from the factory 10. The data collected from the factory may convey the tasks to be performed by the group of machines. The tasks to be performed by the group of machines may depend on the products which are waiting to have their next tasks performed on them by the group of machines and/or on products which are being transferred, for example by an AMHS in the factory, to the group of machines so that their next task can be performed by the group of machines. For example, in FIG. 3, the products 31 to 35 are waiting to be processed by the first group of machines 46 so the tasks to be scheduled on the first group of machines 46 will include the next tasks required in manufacturing the products 31 to 35. The tasks to be scheduled on the first group of machines 46 may also include products which are in transit to the group of machines 46 and which have a predicted transit time for arriving at the rack 55. The products in transit may be being transported around the factory by humans, robots or an AMHS.

The data collected by the means for collecting data from the factory 10 may further comprise a location or locations of the products 31 to 44 in the factory, a location or locations of additional resources, such as the reticles 50, 51, 52, 53, 54, required by the or each group of machines 46, 47, 48, a location of or locations of one or more containers 58 in which the products and/or the additional resources are contained, wherein the one or more containers 58 may comprise PODs in which the reticles are placed while they are being transferred to different locations around the factory, an estimated transit time for an AHMS in the factory to transfer one or more products and/or one or more additional resources to the or each group of machines in the factory, a priority of each product or task; preferences of which machines to use per product per process step and recipes of the machines; which recipes are active in each machine; maximum volume of products to be processed in a machine or in a zone of process steps.

The data collected by the means for collecting data from the factory 10 may additionally or alternatively comprise an operational status of at least one or all of the machines 46A, 46B, 47A, 47B, 47C, 48A, 48B, 49A, 49B, in the factory, such as whether or not a machine is working and/or details of the tasks that the machine is capable of performing.

In order to collect the data, the means for collecting data from the factory 10 may comprise the necessary components to collect the data such as a tracking system, sensors, bar codes, and radio frequency identification tags. The means for collecting data from the factory 10 may comprise components of at least one or all of the machines in the factory.

FIG. 4 show an example of movement of a product, such as one of the semiconductor wafers 31 to 44, as it is moved between different machines in the factory. The product is shown to first have a task 401 performed on it by machine 47A. The product is then moved to a next machine 48A which performs a task 402 on the product. The product is then moved to machine 49B which performs the next task 403 on the product. The product is then moved to machine 48B which performs the next task 404 on the product. The tasks 401 to 404 form a sequence of manufacturing steps in manufacturing the semiconductor wafer.

FIG. 4 also illustrates idle time 405, which is time when the machine is not working to perform a task. The product can be moved manually between the machines or by robots within the factory. FIG. 5 illustrates an example of time link constraints which apply to some sequences of tasks that are performed on the products. A task may need to be performed within a certain time limit of a previous task being completed otherwise the product may not be of an acceptable quality, requiring the product to be reworked or scrapped. For example, in semiconductor wafer fabrication, if a semiconductor wafer is left in a semi-completed state which is not suitable for prolonged exposure to air then undesirable oxidation of the wafer may occur.

FIG. 5 shows a series 510 of tasks 520, 540, 560, 580 which are performed on a product that need to be completed in a certain order. Some of these tasks need to be completed within a certain time of each other, which is shown using “time links” 530, 550, 570 that link some of the tasks 520, 540, 560, 580 together. In this example, the first task 520 is time linked 530 to the second task 540 meaning that the second task 540 needs to be completed within a predetermined time of completion of the first task 520. Similarly, in this example, there is a time link 550 between the second task 540 and the fourth task 580 and another time link 570 between the third task 560 and the final task 580.

In this application, the term “lot” is interchangeably used to refer to a product or a group of products.

In FIG. 5, if the final task 4 cannot be brought forward in time, then scheduling task 3 too soon after the completion of task 2 may make it impossible to meet the predetermined time constraint of time link 3, 570. This is because the time between tasks 3 and 4 is now greater than the maximum time allowed by time link 3, 570. This would not be a problem if the time link constraints were not nested and the schedule only had to be made according to the time Link 2, 550.

Methods for generating a schedule for the group of machines, using the computer systems 1, 20 described above, will now be discussed in detail. It will be appreciated that the methods can be performed to generate a schedule for at least one or each group of machines 46, 47, 48 in the factory.

Although the system and methods are discussed in relation to manufacturing semiconductor devices, the system and methods could alternatively be applied to factories that manufacture different products such as biotech products, or pharmaceutical products, automotive, food, textiles, solar, display and others.

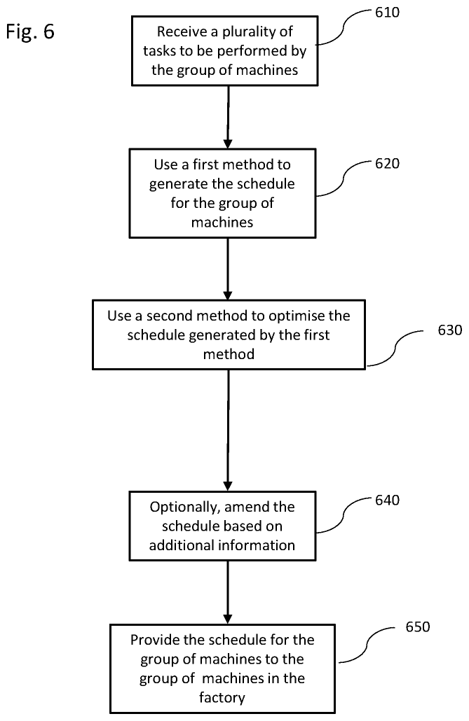

FIG. 6 illustrates computer-implemented method steps which are used to generate a schedule for a group of machines, such as the first group of machines 46, the second group of machines 47 and/or the third group of machines 48 discussed above, in accordance with an embodiment of the present invention.

In step 610, a plurality of tasks to be performed by the group of machines is received. The plurality of tasks may be conveyed in data collected by the means for collecting data from the factory 10

In step 620, a first method is used to generate a schedule for the group of machines. The schedule generated by the first method is a provisional schedule which is later modified by other steps in the method before being provided to the group of machines in the factory. The schedule in step 620 allocates one task of the plurality of tasks or a time-ordered list of some of the plurality of tasks to each machine in the group of machines.

The first method in step 620 may comprise using heuristic rules, dispatch rules, constraint programming, discrete time simulation (which include dispatching rules), or a previously-generated schedule of tasks for the group of machines.

In step 630, a second method is used to optimise the schedule generated by the first method in step 620. The second method could also be referred to as the optimising method and it produces an optimised schedule for the group of machines.

The second method may optimise the schedule for key performance indicators in the factory. Optionally, the first method may optimise the schedule for key performance indicators in the factory. The first method and the second method may optimise the schedule for the group of machines using the same key performance indicators.

The key performance indicators may include one or more of the following: an engineering quality; a speed of production; a cost of production; a throughput of production; a minimum number of violations to timelink constraints (a minimum number of violations may be unavoidable, so this may be treated as a soft constraint which is allowed to be violated and modelled by heavily penalising their violation in the method); a magnitude of a violation of timelink constraints; a batching efficiency weighted by tool, to model the relative cost to the factory of running batches on certain tools over others, and to allow the optimizer to distinguish worsening the batching efficiency at upstream toolsets to realise even greater gains at the more expensive downstream groups of toolsets and minimising the queueing time of lots (this naturally translates into a reduction in cycle time which is often a factory's key objective).

The second optimising method may minimise an objective function.

In one embodiment, the optimising method may ensure that all time link violations are minimised, for example by using job decomposition where lots are scheduled in groups ranked according to how important they are. The optimising method may ensure that no time link or Kanban violations are introduced, and that secondary target outcomes, for example cycle time, on-time delivery and/or batching efficiency, are minimised or met as appropriate.

This approach can allow the second method to optimise the schedule for the group of machines within constraints such as timelink and Kanban constraints.

The second method may comprise Mixed-Integer Linear Programming or constraint programming or any other complex exact mathematical method or advanced heuristic or metaheuristic method. The second method may be computationally more expensive than the first method.

The first method and/or the second method in steps 620 and 630 may use data collected from the factory by the means for collecting data from the factory 10 in generating the provisional schedule and/or in optimising the provisional schedule. The data collected from the factory is discussed in more detail below, and in relation to FIG. 3.

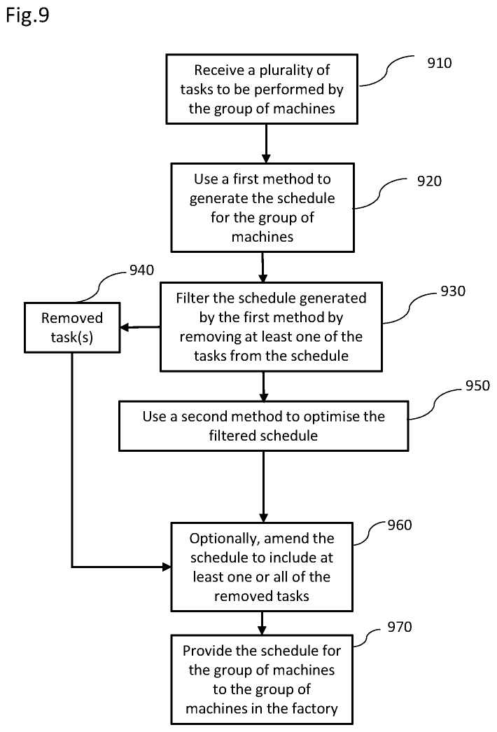

The optimised schedule for the group of machines produced by the second method in step 630 may be provided to the group of machines in the factory in step 650. Alternatively, the optimised schedule for the group of machines may be amended based on additional information in step 640 before it is provided to the group of machines in the factory in step 650. The schedule for the group of machines may be amended in step 640 in view of the filtering processes, and/or or based on updated data, as discussed further below in relation to FIGS. 9 to 12 and 13.

If the method of FIG. 6 is provided with the systems described above in relation to FIGS. 1 and 2, then it is noted that the steps of generating the schedule for the group of machines, including the step of using the first method to generate the schedule for the group of machines in step 620, using the second method to optimise the schedule in step 630, and optionally amending the schedule in step 640, may be performed by the computer system 1 or the local computer system 20.

Providing the schedule to the group of machines in the factory in step 650 may comprise providing the schedule on one or more user interfaces 8 in the factory. Alternatively or additionally, providing the schedule to the group of machines in the factory may comprise using the means to transmit control signals 9 to automatically operate the machines in the group of machines in accordance with the schedule, and/or to automatically operate processes in the factory to enable the machines to operate in accordance with the schedule for the group of machines.

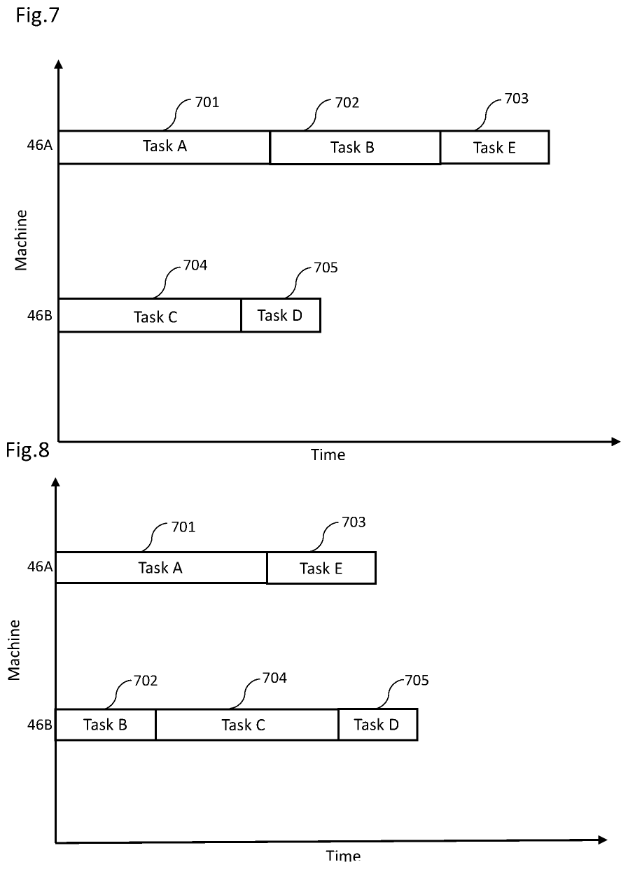

FIG. 7 shows an example of a provisional schedule for the first group of machines 46 which is generated by the first method in step 620. The schedule allocates task A, task B and task E, with reference numbers 701, 702 and 703 respectively, in time order, to machine 46A, and tasks C and task D, with reference numbers 704 and 705 respectively, to machine 46B.

As discussed, each task 701 to 705 is a manufacturing step to be performed in manufacturing a product so, for example, task 701 may be performed on product 31, task 702 may be performed on product 32, task 703 may be performed on product 33, task 704 may be performed on product 34 and task 705 may be performed on product 35.

FIG. 8 shows an example of the schedule from FIG. 7 which has been optimised by the second method in step 630 of FIG. 6. The optimising method has reallocated the tasks between the machines in the group. During the optimising method, task B was found to require earlier processing, for example in order to meet a key performance indicator, so it was moved to the front of the queue on machine 46B. Machine 46B performs processes more quickly than machine 46A.

FIG. 9 illustrates alternative computer-implemented method steps which are used to generate a schedule for a group of machines, such as the first group of machines 46, the second group of machines 47 or the third group of machines 48, in accordance with an embodiment of the present invention.

The method steps are similar to those discussed above in relation to FIG. 6 but there is an additional filtering step 930, after using the first method to generate the schedule for the group of machines and before the schedule is optimised by the second method, in which the schedule generated by the first method in step 920 is filtered by removing at least one of the tasks from the schedule generated by the first method. The second method then optimises the filtered schedule which is generated in step 950 to produce an optimised schedule.

The optimised schedule produced by the second method in step 950 may be provided to the group of machines in the factory in step 970. Optionally, the optimised schedule produced by the second method in step 950 may be amended in step 960 to include at least one or all of the removed tasks 940 that were removed from the schedule during the filtering step 930. The amended optimised schedule for the group of machines from step 960 is then provided to the group of machines in the factory in step 970.

The filtering of the schedule in step 930 may remove any of the tasks from the provisional schedule generated by the first method which are scheduled to being beyond a predetermined time limit.

Alternatively, the filtering of the schedule for the machines in step 930 may remove tasks from the schedule if there are more than a predetermined number of tasks scheduled to occur on a machine. For example, if there are more than three tasks scheduled to occur on one machine, then the filtering step may comprise removing the fourth and above time-ordered tasks scheduled to occur on that machine.

The step of amending the schedule to include at least one or all of the removed tasks in step 960 comprises using an algorithm to add at least one or all of the removed tasks in to the optimised schedule. The algorithm may comprise heuristic rules or constraint programming.

The method steps in FIG. 9 have corresponding features which have already described above in relation to FIG. 6. However, for the sake of completeness, it is noted that the first method in step 920 generates a provisional schedule which allocates one task of the plurality of tasks or a time-ordered list of some of the plurality of tasks to each machine in the group of machines. The first method may comprise using heuristic rules, dispatch rules, constraint programming, discrete time simulation (which include dispatching rules), or a previously-generated schedule of tasks for the group of machines. The second method in step 950 may comprise Mixed-Integer Linear Programming or constraint programming or any other complex exact mathematical method or advanced heuristic or metaheuristic method. The second method may be computationally more expensive than the first method.

The second method and optionally the first method may optimise the schedule for key performance indicators, examples of which are provided above in relation to FIG. 6.

The first method and/or the second method in steps 920 and 950 may use data collected from the factory by the means for collecting data from the factory 10 in generating the provisional schedule and/or in optimising the provisional schedule. The data collected from the factory is discussed elsewhere in this application.

If the method of FIG. 9 is provided with the system of FIG. 1, then it is noted that the steps of generating the schedule for the group of machines, including the step of using the first method to generate the schedule for the group of machines in step 920, filtering the schedule in step 930, using the second method to optimise the schedule in step 950, and optionally amending the schedule in step 960, may be performed by the computer system 1, or the local computer system 20 from FIG. 2. The computer system 1 provides the schedule for the group of machines to the group of machines in the factory in step 970 via the communications means 8, 9.

The data may be received at the computer system 1, 20, from the means for collecting data from the factory 10, multiple times at a first frequency, and the schedule for the group of machines may be generated and provided to the factory each time that the data is received at the first frequency according to the steps shown and described in relation to FIG. 9. Providing the schedule to the group of machines in the factory in step 970 may comprise providing the schedule on one or more user interfaces in the factory, then operators execute the task based on the task recommended on the user interface. Alternatively or additionally, providing the schedule to the group of machines in the factory in step 970 may comprise using the means to transmit control signals 9 to automatically operate the machines in the group of machines in accordance with the schedule, and/or to automatically operate processes in the factory to enable the machines to operate in accordance with the schedule for the group of machines.

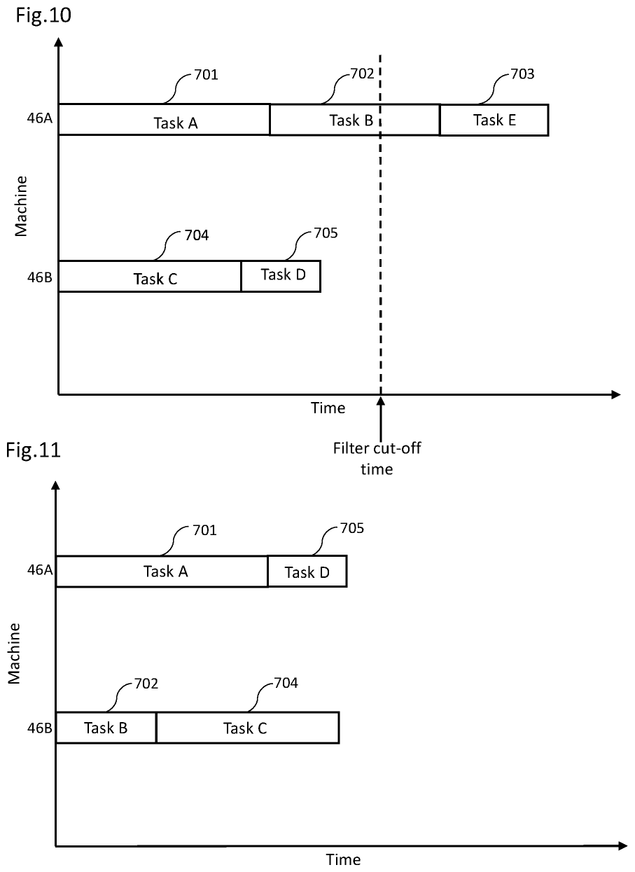

FIG. 10 shows an example of a schedule for the first group of machines 46 which is generated by the first method in step 920. The schedule allocates task A, task B and task E, with reference numbers 701, 702 and 703 respectively, to machine 46A, and tasks C and task D, with reference numbers 704 and 705 respectively, to machine 46B. FIG. 10 shows a filter cut off time. Task E is scheduled to being after the filter cut off time.

The schedule of FIG. 10 is then filtered in step 930 to remove any of the tasks which are scheduled to being after the filter cut off time. This results in task E being removed from the provisional schedule generated by the first method. The filtered schedule therefore comprises only the remaining tasks A, B, C and D.

In step 950, the second method then optimises the remaining tasks in the filtered provisional schedule. In this case, the second method optimises tasks A, B, C and D. FIG. 11 shows an example of the schedule for the group of machines after it has been optimised by the second method in step 950.

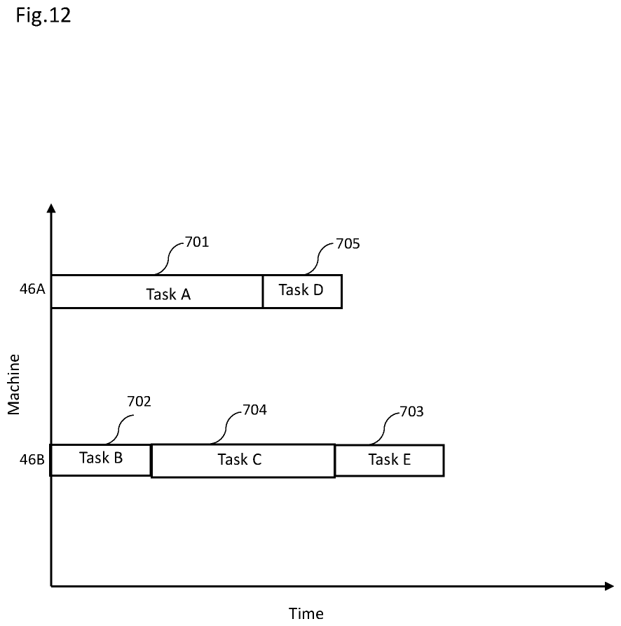

Optionally, in step 960, the removed tasks 940 may then be added back into the optimised schedule which was generated by the second method in step 950. FIG. 12 shows the optimised schedule for the group of machines from FIG. 11 after it has been amended in step 960 to include the removed task, task E.

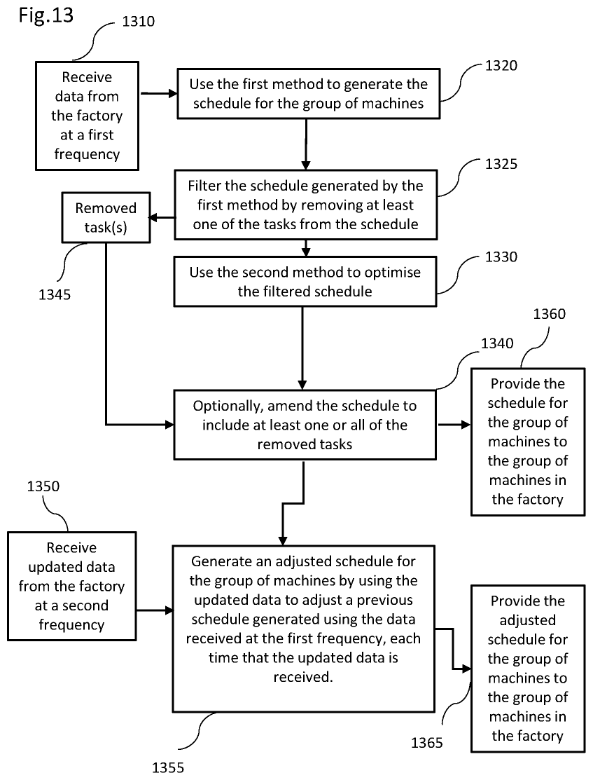

FIG. 13 illustrates alternative computer-implemented method steps which are used to generate a schedule for a group of machines, such as the first group of machines 46, the second group of machines 47 or the third group of machines 48 discussed above, in accordance with an embodiment of the present invention.

The method steps are similar to those discussed above in relation to FIGS. 6 and 9 except that the method uses data received from the factory at a first frequency and a second frequency.

In step 1310, the data is received from the factory at a first frequency. As discussed above, the data may be collected from the factory by the means for collecting data from the factory 10, and sent to the computer system 1, or the local computer system 20 for the computer system 1 or the local computer system 20 to generate the schedule for the group of machines.

A first method is used to generate the schedule for the group of machines in step 1320, using the data received at the first frequency. The method in step 1320 allocates one task of the plurality of tasks or a time-ordered list of some of the plurality of tasks to each machine in the group of machines. The schedule generated by the first method is a provisional schedule which is later modified by other steps in the method before being sent to the group of machines in the factory.

The first method in step 1320 may comprise using heuristic rules, dispatch rules, constraint programming, discrete time simulation (which include dispatching rules), or a previously-generated schedule of tasks for the group of machines.

In step 1325, the provisional schedule generated by the first method in step 1320 is filtered by removing at least one of the tasks from the schedule for the group of machines. The filtering in step 1325 is the same as the filtering described above in more detail in relation to step 930 of FIG. 9, and FIGS. 10 to 12.

The filtering of the schedule in step 1325 may remove any of the tasks from the provisional schedule generated by the first method which are scheduled to being beyond a predetermined time limit.

Alternatively, the filtering of the schedule for the machines in step 1325 may remove tasks from the schedule if there are more than a predetermined number of tasks scheduled to occur on a machine.

In step 1330, a second method optimises the filtered schedule from step 1325. The second method in step 1330 may comprise Mixed-Integer Linear Programming or constraint programming or any other complex exact mathematical method or advanced heuristic or metaheuristic method. The second method may be computationally more expensive than the first method from step 1320.

The second method in step 1330 and optionally the first method in step 1320 may optimise the schedule for key performance indicators, examples of which are provided above in relation to FIG. 6. The optimised schedule from step 1330 may be provided to the group of machines in the factory in step 1360.

Optionally, the optimised schedule produced by the second method in step 1330 may be amended in step 1340 to include at least one or all of the removed tasks 1345 that were removed from the schedule during the filtering step 1325. The amended optimised schedule for the group of machines from step 1340 is then provided to the group of machines in the factory in step 1360.

The second method in step 1330 may decompose the tasks to be scheduled into chunks. Each chunk of tasks may be individually optimised by the second method. After a chunk of tasks is optimised the tasks in this chunk are then fixed. The second method then optimises and fixes the next chunk of tasks. The second method continues to optimise and fix subsequent chunks of tasks until all chunks of tasks have been optimised and fixed.

The method steps described above in relation to step 1330 may also be performed by the second method in step 630 of FIG. 6 and step 950 of FIG. 9.

The step of amending the schedule to include at least one or all of the removed tasks in step 1340 comprises using an algorithm to add at least one or all of the removed tasks in to the optimised schedule. The algorithm may comprise heuristic rules or constraint programming.

The steps of generating the schedule, including steps 1320, 1325, 1330, and optionally step 1340, and the step of providing the schedule to the group of machines in the factory in step 1360, are performed each time that the data is received from the factory at the first frequency.

The method steps 1320, 1325, 1330, 1340, use the data received from the factory at the first frequency from step 1310 to generate the schedule for the group of machines. Specifically, the first method in step 1320 may use the data from the factory received at the first frequency to generate the schedule for the group of machines. Additionally, or alternatively, the second method in step 1340 may optimise the schedule using the data received from the factory at the first frequency.

The data received from the factory at the first frequency may include one or any combination of: the plurality of tasks to be performed by the group of machines; a location of each product of a plurality of products on which the plurality of tasks are to be performed; a location or locations of additional resources required by the group of machines to perform the plurality of tasks; a location or locations of one or more containers in which additional resources required by the group of machines to perform the plurality of tasks is contained; a transit time to transfer one or more of the products on which the plurality of tasks are to be performed to the group of machines using, for example, an Automated Material Handling System (AHMS); a transit time to transfer one or more of the additional resources that are required by the group of machines to perform the plurality of tasks to the group of machines using, for example, an AHMS; an operational status of one or more machines in the group of machines; a current task being performed by one or more of the machines of the group of machines; an idle state of one or more of the machines; a maintenance state of one or more of the machines; a demand of one or more of the products; a priority of one or more products; specific due dates of one or more products; a priority of each product or task; preferences of which machines to use per product per process step and recipe of the machines; which recipes are active in each machine; maximum volume of products to be processed in a machine or in a zone of process steps.

Although FIG. 13 shows a filtering step 1325, in one embodiment this is optional and the filtering step 1325, and the removed tasks 1345 and the optional step of amending the schedule to include at least one or all of the removed tasks 1340 are not present.

FIG. 13 shows that the method may further comprise receiving updated data from the factory multiple times at a second frequency in step 1350. The second frequency may be higher than the first frequency. For example, the second frequency is 30 seconds and the first frequency is 5 minutes.

The updated data may be collected from the factory by the means for collecting data from the factory 10, and sent to the computer system 1 or the local computer system 20 by the means for sending the data to the computer system 11 for the computer system 1, 20 to adjust the schedule for the group of machines.

In step 1355, the method generates an adjusted schedule for the group of machines by using the updated data received in step 1350 to adjust a previous schedule generated using the data received at the first frequency.

In step 1355, the method may receive the optimised schedule for the group of machines generated by the second method step 1330, or it may receive the amended optimised schedule for the group of machines generated in step 1340 if this optional step is being performed. The optimised schedule or the amended optimised schedule constitutes a previous schedule which is then adjusted using the updated data in step 1355. The adjusted schedule for the group of machines is then provided to the group of machines in the factory in step 1365.

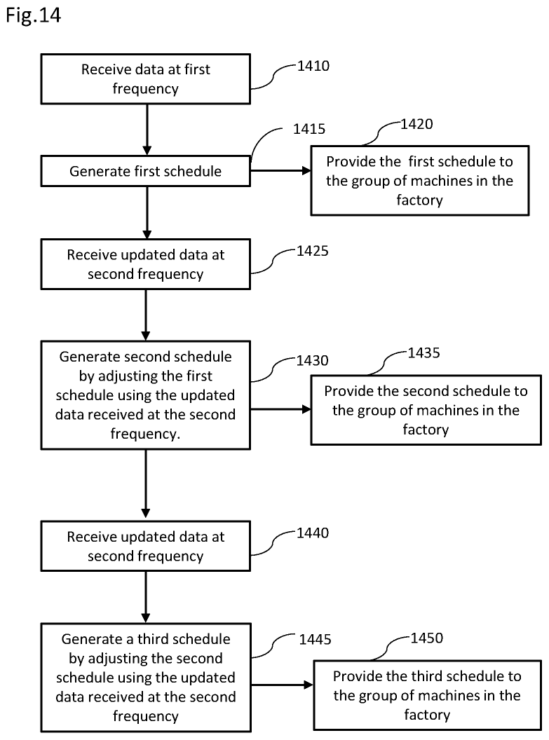

An adjusted schedule may be generated and provided to the factory in steps 1355 and 1365 each time that the updated data is received at the second frequency. The steps of generating the adjusted schedule each time that the updated data is received in step 1355 comprises an iterative process which described in more detail in relation to FIG. 14.

FIG. 14 illustrates a sequence of schedules for the group of machines that are generated by the method of FIG. 13. The method generates a first schedule for the group of machines 1415 using the data received at the first frequency 1410. The first schedule may be the optimised schedule which is generated in step 1330 or the amended optimised schedule from step 1340. The first schedule is then provided to the group of machines in the factory in step 1420, which corresponds to step 1360 in FIG. 13.

The first schedule 1415 is then adjusted using updated data that is received at the second frequency in step 1425 to generate the second schedule for the group of machines in step 1430. The second schedule is then provided to the group of machines in the factory in step 1435.

The second schedule 1430 is then adjusted using updated data which is next received at the second frequency in step 1440 to generate the third schedule for the group of machines in step 1445. The third schedule is provided to the group of machines in the factory in step 1450.

The next time that data is received at the first frequency, steps 1320 to 1330, and optionally step 1340, are repeated to generate a new schedule which then constitutes the

previous schedule which is adjusted using the updated data in step 1355. Using the updated data to adjust the previous schedule generated for the group of machines in step 1355 may comprise using an algorithm to adjust the previous schedule. The algorithm may comprise an optimisation based approach or heuristics or constraint programming, for example.

The updated data received at the second frequency may be a subset of the data received at the first frequency.

The updated data from the factory may comprise one or any combination of: an additional task or tasks to be performed by the group of machines; a location of each product of a plurality of products, 31 to 44, on which the plurality of tasks are to be performed; a location or locations of additional resources, 50 to 54, required by the group of machines to perform the plurality of tasks; a location or locations of one or more containers 58 in which additional resources required by the group of machines to perform the plurality of tasks is contained; a transit time to transfer one or more of the products on which the plurality of tasks are to be performed to the group of machines using, for example, an Automated Material Handling System (AHMS); a transit time to transfer one or more of the additional resources that are required by the group of machines to perform the plurality of tasks using, for example, an AHMS; an operational status of one or more machines 46A, 46B, 47A, 47B, 47C, 48A, 48B, 49A, 49B in the group of machines; a current task being performed by one or more of the machines of the group of machines; an idle state of one or more of the machines; a maintenance state of one or more of the machines; when a machine comes back online; a demand of one or more of the products; a priority of one or more products; specific due dates of one or more products; a priority of each product or task; preferences of which machines to use per product per process step and recipe of the machines; which recipes are active in each machine; when a recipe goes offline or comes back online; maximum volume of products to be processed in a machine or in a zone of process steps.

For example, if the updated data received in step 1350 indicates that an additional task is to be performed by the group of machines, which task was not present in the previously generated schedule, then the previously generated schedule is adjusted in step 1355 to include the additional task. The additional task may be indicated if, for example, a new product has arrived on a rack next to the group of machines which was not present on the rack when the previous schedule was prepared.

Alternatively, the updated data may indicate that one of the machines in the group has broken down so adjusting the previous schedule in step 1355 comprises reallocating the scheduled tasks between the remaining working machines in the group.

Alternatively, the updated data may indicate that one of the products has violated a time link so that product is no longer viable, so adjusting the previous schedule in step 1355 comprises removing any tasks from the previous schedule that are related to the inviable product.

Providing the schedule or the adjusted schedule in steps 1360 and 1365 to the group of machines in the factory may mean outputting the schedule or the adjusted schedule on one or more user interfaces in the factory. Additionally or alternatively, providing the schedule or the adjusted schedule to the group of machines in the factory may comprise using the means to transmit control signals 9 to automatically operate the machines in the group of machines in accordance with the schedule, and/or to automatically operate processes in the factory to enable the machines to operate in accordance with the schedule for the group of machines.

If the method of FIG. 13 is provided with the system of FIG. 1, then it is noted that the steps of generating the schedule for the group of machines, including the step of using the first method to generate the schedule for the group of machines in step 1320, filtering the schedule in step 1325, using the second method to optimise the schedule in step 1330, and optionally amending the schedule in step 1340, may be performed by the computer system 1.

Furthermore, the step of generating the adjusted schedule in step 1355 may be performed by the computer system 1.

In an alternative embodiment, the first and the second frequencies are the same, and the method only generates one adjusted schedule based on the updated data.

In another alternative embodiment, the data is sent to the factory at one frequency but this data is sampled at a first frequency to generate the schedule using steps 1320, 1325, 1330 and optionally step 1340, and provided to the group of machines at the first frequency. The data received is additionally sampled at a second frequency, which is higher than the first frequency, to generate the adjusted schedule in step 1355.

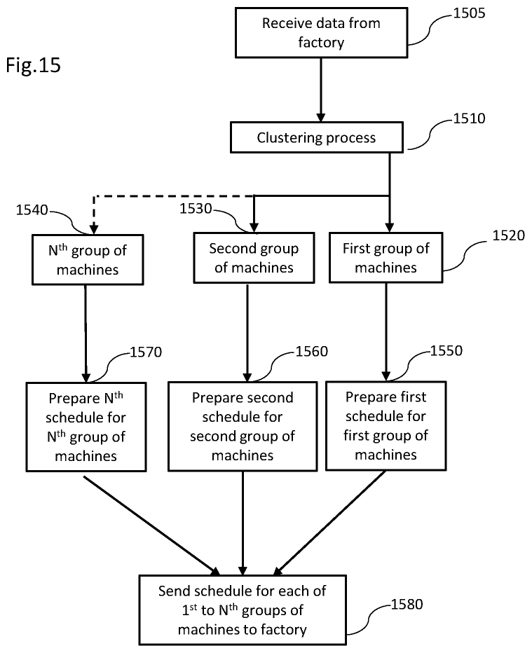

FIG. 15 shows an example of a computer-implemented clustering method 1500 which is used to subdivide the machines in the factory into different groups of machines. The clustering process may be implemented on the computer system for the local computer system 20. Data is received from the factory in a first step 1505, wherein the data comprises data about the machines in the factory such as what type of machine each machine is, and which tasks it performs. A clustering process is performed in step 1510 in which the machines are divided into groups of machines, such as a first group of machines 1520, a second group of machines 1530, up to an Nth group of machines 1540. The schedule is then prepared for each group of machines 1520, 1530, 1540, using a computer-implemented method, such as those described above in relation to FIGS. 6, 9 and 13.

With reference to FIG. 15, the schedule is prepared for the first group of machines in step 1550, the schedule is prepared for the second group of machines in step 1560, and the schedule is prepared for the Nth group of machines in step 1570. There may be a large number of groups of machines and the Nth group is the annotation for the highest group number.

Once the schedules have been prepared for each of the groups of machines, the schedule for each of the first to the Nth groups of machines is sent to the factory in step 1580.

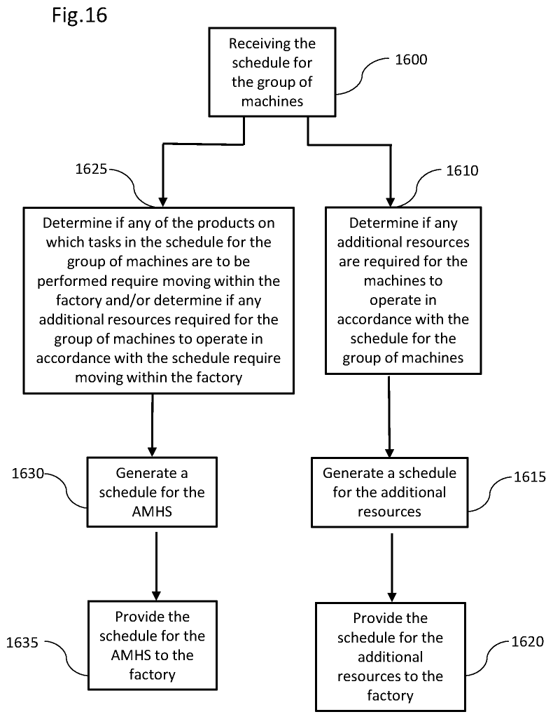

With reference to FIG. 16, once a schedule has been generated for a group of machines, as described herein, for example using the methods described in relation to FIGS. 6, 9 and 13, the computer-implemented method may additionally generate a schedule of additional resources required by the group of machines to perform the plurality of tasks according to the schedule for the group of machines., for example which reticles to use for a photolithography tool, which pods to use for the reticles. The computer-implemented method may additionally or alternatively generate a schedule for an Automated Material Handling System (AMHS) i.e. a robotic system to move the products on which the tasks are to be performed and/or the additional resources around the factory so that the group of machines can operate in accordance with their schedule. These schedules are further discussed in relation to FIG. 16, which describes computer-implemented method steps that may be performed by the computer system1 or the local computer system 20.

In a first step 1600, the schedule for the group of machines, generated by the methods described above, is received. In step 1610, the method determines if any additional resources, such as reticles, are required for the machines to operate in accordance with the schedule for the group of machines, for example by accessing a database which contains data as to which additional resources are required to perform the tasks in the schedule for the group of machines.

In step 1615, the method generates a schedule for the additional resources, comprising allocating the additional resources to one or more machines of the group of machines so that the group of machines can operated in accordance with the schedule for the group of machines. The schedule of the additional resources is then provided to the factory in step 1620.

Providing the schedule of the additional resources to the factory may comprise outputting the schedule of the additional resources on one or more user interfaces in the factory. Alternatively or additionally, providing the schedule of additional resources to the factory may comprise using the means to transmit control signals 9 to automatically operate processes in the factory to prepare the additional resources for use in the schedule and/or automatically moving the additional resources to locations required by the schedule for the additional resources for example by robots.

In generating the schedule for the AMHS, the method first receives the schedule for the group of machines in step 1600. The method then determines in step 1625 if any of the products on which the plurality of tasks in the schedule are to be performed and/or any of the additional resources required by the group of machines to perform their allocated tasks need to be moved within the factory so that the group of machines can operate in accordance with the schedule for the machines. The method then generates a schedule for the AMHS in step 1630, which comprises instructions for the AHMS to automatically move one or more of the products and/or one or more additional resources within the factory so that the group of machines can operate in accordance with the schedule for the group of machines.

The schedule for the AHMS is provided to the factory in step 1635. Providing the schedule for the AHMS to the factory may comprise transmitting control signals to the AMHS so that the AHMS automatically operates in accordance with the schedule for the AMHS, and/or outputting the schedule for the AHMS on one or more user interfaces.

In an alternative embodiment, the schedule for the group of machines and the schedule for the additional resources and the schedule for the AMHS are all generated at the same time considering all of the resources together.

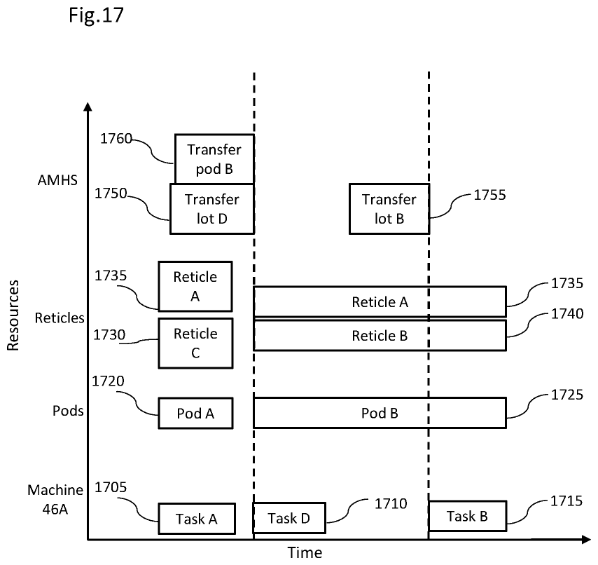

The computer-implemented method may combine the schedule for the group of machines and the schedules for the additional resources and the AHMS in a single schedule which is provided to the factory. FIG. 17 shows an example of a combined schedule which is generated and provided to the factory. The schedule of FIG. 17 is produced when the solution strategy considers all the resources and tasks at the same time. In FIG. 17, the schedule comprises tasks A, D, and B, with reference numbers 1705, 1710 and 1715, which are scheduled to be performed by a machine 46A of a group of machines. To perform Task A, the machine requires reticle A with reference number 1735 and reticle C with reference number 1730. Therefore, the schedule allocates reticles A and C to the machine 46A so that they are present at the machine at the same time that task A is scheduled to be performed. Reticles A and C are located in a container, pod A 1620, so pod A is scheduled to be located at the machine 46 A when task A is being performed.

To perform task D, 1710, lot D is required on which the task is to be performed. The schedule therefore contains instructions to the AMHS to transfer lot D in step 1750 so that lot D is present at the machine 46A for the scheduled task D to be performed on it. Task D requires reticle B 1740 as necessary equipment to perform the task. Reticle B is located in pod B, which was not previously located at the machines 46A, so the schedule includes instructions for the AMHS to move pod B from its previous location to the machine 46A so that reticle B is present and can be used by the machine in performing task D at its scheduled time. Reticle A, 1735, is also required by the machine to perform task D, but reticle A does not need to be moved since it is already present at the machine 46A from performing task A.

Additionally, the machine 46A is scheduled to perform task B, 1715. The schedule includes instructions to the AMHS to transfer lot B, 1755, to the machine in time for the task B to be performed on lot B.

The tasks to be scheduled on the group of machines, in any of the methods described above, may each have a priority value associated therewith. The first method may generate the provisional schedule using the priority values of the tasks and/or the second method may optimise the schedule using the priority values of the tasks.

The priority value informs the relative urgency of the task compared to other tasks. For example, a task with a priority value of 1 may be the most urgent type of task, and a task with a priority value 10 would be the least urgent type of task. Tasks with more urgent priority values need to be scheduled ahead of tasks with less urgent priority values.

In another example, the first method described herein may alternatively or additionally use predetermined targets for the machines in the group of machines when generating the provisional schedule and/or the second method described herein may use predetermined targets for the machines in the group of machines when optimising the schedule. The predetermined targets may include, for example, the number of lots per hour or per day that each machine is aiming to operate on.

In another example, the first method and/or the second method may alternatively or additionally use Kanban limits, or the cost of each batch. A batch is the term for a group of wafers which are processed together.

The priority values of the tasks and/or the predetermined targets for the machines may be generated by a separate method which considers historical data from the factory and all of the machines and processes within the factory. Alternatively, the priority values and/or the predetermined targets for the machines may be generated by a separate method such as a method of a planning system of the factory.

The first method and/or the second method described above may use WIP targets; priorities; due dates; release data; WIP targets and/or toolset and product restrictions and other relevant data in generating or optimising the schedules for the group of machines.

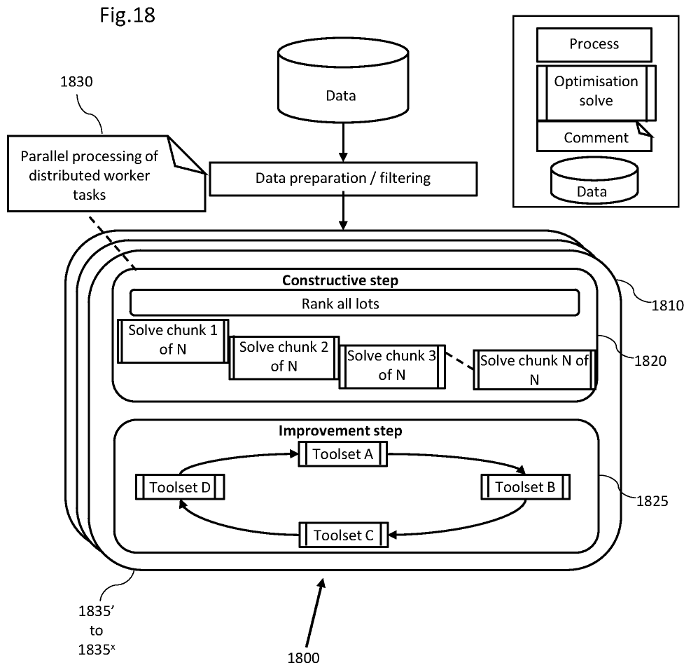

FIG. 18 shows further details of an example optimising method 1810 which can be used in the second method described above in relation to FIGS. 6, 9 and 13, for optimising the schedule for a group of machines when the group of machines comprises more than one type of machine. The example group of machines in FIG. 18 includes four toolsets A, toolset B, toolset C and toolset D. Each toolset has a group of machines which perform similar tasks, for example the machines in toolset A are cleaning machines such as wet benches and the machines in toolset B are furnace machines.

The optimising method comprises a two-stage solution strategy with a constructive step 1820 and an improvement step 1825. The constructive step produces a high-quality schedule quickly, typically within 2-3 minutes. The improvement step refines this schedule carefully, leading to a better solution for a further 2-3 minutes. These two steps are encapsulated within a distributed processing environment of multiple threads processing tasks in parallel 1830.

The constructive step 1820 is focused around an iterative process of adding decreasingly important lots into the schedule. All the lots are ranked according to a combination of criteria, q (lot). They are then scheduled in N subsets, a predefined number N of iterations. Higher priority is allowed to tasks with earliest due date, more time link constraints and higher number of steps to be scheduled. Tasks are sorted in non-decreasing order with respect to their due dates. Adding the number of time link constraints and the number of steps to schedule gives a better view on the priority of a task. Increasing the priority of these lots results in scheduling them in earlier iterations where there is more freedom in the schedule. All future and time-linked steps of a lot are considered simultaneously in the iteration for which it is selected.

In taking a task decomposition approach, we iteratively solve smaller subproblems where each subproblem contains only a subsets of the total number of tasks. This reduces the total complexity of the problem, which is principally derived by the number of tasks to be scheduled. Subproblems are iteratively solved using MILP.

The algorithm of this constructive step can be described as follows:
1. Determine the bottleneck toolsets coupled by time link constraints
2. Build an MILP model encompassing these coupled toolsets
3. Rank all lots according to q (lot) in descending order
4. Split the ranked tasks into N chunks of equal number of schedulable tasks
5. Solve the MILP problem of each iteration, adding each chunk of tasks in successive iterations

During the iterative solutions of the MILP, tasks of previous iterations are not allowed to move batches however they may still change their timing and/or sequencing. The maximum running time of this stage is evaluated according to the number of tasks to be scheduled. The division of the total time limit is skewed towards earlier iterations as these are typically more complex subproblems to solve due to the ranking criteria of lots. The advantage of this step is the possibility of including all time link constraints of tasks in each chunk. Otherwise, solving the full problem with coupled time link constraints for industrial size datasets would not be possible in a reasonable amount of time.

The improvement step 1825 is the second and final phase of the solution strategy consisting of cycling through the bottleneck machine groups considering one machine group at a time. Given a full MILP model of the entire fab, we only allow decision variables related to the machine group at hand to be modified by the solver in any given iteration. In doing so, the problem size is effectively reduced however we ensure the impact on the timing of the steps on other machine groups is also still considered in the objective function of this machine group.

Furthermore, we allow lots to move within a “close neighbourhood” of candidate batches. This neighbourhood is defined for a given batch IB as any other batch B* that has been pre-assigned the same recipe and starts or ends within a minutes of the candidate batch. A batch is a group of products which are processed together. To simplify this search, batches that are already full on machine groups with a high maximum batch size are considered immutable; their lots are excluded from this local neighbourhood search. We also allow the search to move lots between machines of a machine group.

This improvement step 1825 procedure continues iterating until either all machine groups have successfully returned an optimal solution in a single pass or the predefined time limit has been exceeded.

Another facet of this solution strategy is the lexicographic objective function that is used for the MILP model. A linear weighted sum of different objectives is typically how objective functions with many different Key Performance Indicators (KPIs) are composed. In this instance, however, the objectives have significantly different priorities and having linear weights that are several orders of magnitude different can cause the optimiser to become unstable.

For this reason, in this embodiment the objective function is modified to be hierarchical such that: it optimises a first objective function f₁(x) only; then it optimises the second objective function f₂ (x) such that f₁(x) does not worsen by μ % (typically 0-10%). The objective functions are objective terms which are optimised. This is especially useful when dealing with different orders of magnitude in the objective terms of considerably different coefficients because only one sub-problem is considered at a time. This further enables us to model the time link constraints via an objective function penalty term and once the number of time links has been minimised without considering any confounding KPIs, the remaining terms can be optimised given that number of time link violations. Optimising time links is best suited to a lexicographic objective for three reasons:
1. Infeasibility: Should time links be treated as hard constraints, the problem may end up being infeasible due to potential limited fab capacity. Hence we minimise them as part of the objective function instead of disallowing any violations at all.
2. Importance: Additionally, a lexicographic objective gives us the ability to highly prioritise this objective term above all else. Since the cost of violating a time link is so great to a fab (due to potentially scrapping a wafer or performing rework), any improvements in the other KPIs are overshadowed by this term.
3. Automation: The solution of this embodiment is deployed in a live application where the time available for decision making and human interventions is limited, therefore relevant objective preferences should be set up-front and optimised accordingly.

In the described embodiment, the objective function is set up with the following ranking:
1. Above all else, eliminate all time link violations as much as possible
2. Secondarily, maximise the batching efficiency weighted by tool
3. Finally, minimise the queuing time of lots

Notably, solving the problem in this fashion could lead to a situation where the queueing time of lots suffers at the expensive of optimal batching efficiency and time link violations; the solution is not the same as if all terms were optimised together. In using such an approach, we have also considered that the objectives are in order of “freedom”. That is to say that when optimising the third term, a constrained number of time link violations and batching efficiency still allows a large number of solutions to be explored. We have not constrained precise jobs in the way that optimising queueing time (or say, job end times) first would do.

In other embodiments, further fine-tuning the lexicographic order of our objective function can be performed.

As the modelling parameters need to be decided a priori, in the described embodiment parallel computing 1830 is used to launch similar computations with subtly different configurations and inspect the results upon completion. Typically we run approximately 10different parallel threads whose output schedules are assessed according to a success criterion chosen by the parent thread. For example, multiple variations 1835¹ to 1835^{x} can be processed in parallel.

By using a highly-distributed cloud platform in some embodiments, or a sufficiently computationally powerful computer system, many similar solution strategies can be simulated in parallel with subtly different tuning parameters. Of the final results that these simulations produce, they can be compared using predetermined assessment criteria for schedule quality and the substantially optimal/best schedule is selected for use to manufacture the products.

Any system feature as described herein may also be provided as a method feature, and vice versa. As used herein, means plus function features may be expressed alternatively in terms of their corresponding structure.

Any feature in one aspect may be applied to other aspects, in any appropriate combination. In particular, method aspects may be applied to system aspects, and vice versa. Furthermore, any, some and/or all features in one aspect can be applied to any, some and/or all features in any other aspect, in any appropriate combination.

It should also be appreciated that particular combinations of the various features described and defined in any aspects can be implemented and/or supplied and/or used independently.

The following numbered statements are not to be considered as claims:

Statement 1: A method of generating scheduling data for a machine comprising: receiving tasks to be scheduled on the machine;

determining one or more related machines and at least one related task per related machine; wherein said at least one related task comprises a task upon which at least one of said tasks to be scheduled on the machine are dependent;
using a predictive model to determine a substantially optimal order of the tasks to be scheduled on the machine based on the related tasks; and generating scheduling data comprising a set of scheduled tasks.

Statement 2: The method of statement 1, wherein the machine is operable to perform any or any combination of: wafer fabrication; semiconductor wafer fabrication; semiconductor manufacturing; computer chip manufacturing; automotive manufacturing; computer manufacturing; computer hard drive manufacturing; computer memory manufacturing.

Statement 3: The method of any of statements 1 or 2, further comprising receiving any or any combination of: a state of the one or more related machines; an initial state of one or more resources; a state of a fabrication facility: one or more locations of any relevant products; a current task of one or more of the machines; an idle state of one or more of the machines; a maintenance state of one or more of the machines; a demand of one or more of the products; a priority of one or more products; specific due dates of one or more products.

Statement 4: The method of any of statements 1 to 3, comprising any or any combination of pre-processing steps including any or any combination of: validating input data quality; reconstructing input data; combining input data to generate parameter values.

Statement 5: The method of any of statements 1 to 4, wherein the machine is operable to manufacture any or any combination of: computer chips; computer memory; computer storage; semiconductors; wafers; hard drives; random access memory; solid state memory; storage chips.

Statement 6: The method of any of statements 1 to 5, wherein the machine comprises any or any combination of: metrology equipment; furnace equipment; cleaning equipment; photolithography equipment.

Statement 7: The method of any of statements 1 to 6, wherein the tasks and/or related tasks comprises a priority value and wherein the priority value of each of the tasks and/or related tasks indicates any or any combination of: an urgency value; an importance value; a relative urgency value; a relative importance value.

Statement 8: The method of any of statements 1 to 7, wherein the one or more predictive models comprise any or any combination of: a mixed integer linear programming model; heuristics; complex flexible job-shop-scheduling problem with time link constraints model; integer programming model; metaheuristics; mixed integer programming model; genetic algorithm; simulated annealing; greedy randomised adaptive search procedure; constraint programming model; Monte Carlo methods; multivariate predictive models; relaxed mixed integer linear programming model.

Statement 9: The method of any of statements 1 to 8, wherein the method is repeated in iterations over a period of time.

Statement 10: The method of any of statements 1 to 9, wherein using a predictive model comprises performing one or more simulations.

Statement 11: The method of statement 10 wherein performing one or more simulations comprises predicting one or more violations that would result in manufacturing defects and wherein determining the substantially optimal predicted outcome comprises substantially minimising predicted violations.

Statement 12: The method of statement 11 wherein the machine receives a predetermining tolerance level of violations and wherein substantially minimising predicted violations comprises determining that the substantially optimal predicted outcome results in fewer violations than the predetermining tolerance level of violations.

Statement 13: A system comprising a plurality of machines and operable to perform the method of any one of statements 1 to 12 at each of said plurality of machines.

1-26. (canceled)

27. A system for providing a schedule for a group of machines in a factory, the system comprising a computer system for generating the schedule for the group of machines, and a communication means for providing the schedule to the group of machines in the factory, wherein the computer system is configured to generate the schedule for the group of machines by performing the steps of:
receiving a plurality of tasks to be performed by the group of machines;
using a first method to generate the schedule for the group of machines, comprising allocating one task of the plurality of tasks or a time-ordered list of some of the plurality of tasks to each machine of the group of machines; and
using a second method to optimise the schedule generated by the first method;
and wherein the computer system is further configured to provide the schedule for the group of machines to the group of machines in the factory via the communication means.

28. The system of claim 27, wherein the computer system is further configured to perform a filtering step after using the first method to generate the schedule, wherein the filtering step comprises generating a filtered schedule by removing at least one of the plurality of tasks from the schedule generated by the first method, and wherein using the second method to optimise the schedule generated by the first method comprises optimising the filtered schedule.

29. The system of claim 28, wherein removing at least one of the plurality of tasks from the schedule generated by the first method comprises removing any of the plurality of tasks which are scheduled to begin beyond a predetermined time limit.

30. The system of claim 28, wherein after using the second method to optimise the schedule, the computer system is further configured to amend the schedule to include at least one or all of the tasks that were removed from the schedule during the filtering step.

31. The system of claim 27, further comprising a means for collecting data from the factory, and a means for sending the data to the computer system, and optionally wherein the data conveys the plurality of tasks to be performed by the group of machines.

32. The system of claim 31, wherein the computer system is configured to generate the schedule for the group of machines using the data from the factory.

33. The system of claim 32, wherein the means for sending the data to the computer system is configured to send the data to the computer system multiple times at a first frequency, and wherein each time the computer system receives the data at the first frequency, the computer system is configured to generate the schedule for the group of machines using the data received at the first frequency, and to provide the schedule to the group of machines via the communication means.

34. The system of claim 33, wherein the means for collecting data from the factory collects updated data from the factory, and wherein the means for sending the data to the computer system is configured to send the updated data to the computer system multiple times at a second frequency, and optionally wherein the second frequency is higher than the first frequency.

35. The system of claim 34, wherein the computer system is configured to generate an adjusted schedule for the group of machines by using the updated data to adjust a previous schedule that was generated for the group of machines using the data received at the first frequency, and to provide the adjusted schedule to the group of machines via the communication means.

36. The system of claim 35, wherein using the data to adjust the previous schedule comprises an iterative process, wherein each time that the updated data is received at the second frequency, the updated data is used to update the adjusted schedule.

37. The system of claim 34, wherein the updated data comprises at least one additional task to be performed by the group of machines, and wherein adjusting the previous schedule comprises amending the previous schedule to include the at least one additional task.

38. The system of claim 31, wherein the data from the factory and/or the updated data comprises one or any combination of: a location of each product of on which the plurality of tasks are to be performed; a location or locations of additional resources required by the group of machines to perform the plurality of tasks; a location or locations of one or more containers in which additional resources required by the group of machines to perform the plurality of tasks is contained; a transit time to transfer one or more of the products on which the plurality of tasks are to be performed to the group of machines using, for example, an Automated Material Handling System (AMHS); a transit time to transfer one or more of the additional resources that are required by the group of machines to perform the plurality of tasks to the group of machines using, for example, an AMHS; an operational status of one or more machines in the group of machines; a maintenance state of the one or more machines; when a machine comes back online; a priority of each product or task; preferences of which machines to use per product per process step and recipe of the machines; which recipes are active in each machine; when a recipe goes offline or comes back online; maximum volume of products to be processed in a machine or in a zone of process steps.

39. The system of claim 27, wherein the computer system is further configured generate a schedule for additional resources required by the group of machines to perform the plurality of tasks, wherein the schedule for additional resources allocates the additional resources to one or more machines in the group of machines so that the group of machines can operate in accordance with the schedule for the group of machines, and wherein the computer system is further configured to provide the schedule of additional resources to the factory via the communication means.

40. The system of claim 27, wherein the computer system is further configured to generate a schedule for an Automated Material Handling System (AMHS) in the factory, wherein the schedule for the AMHS comprises instructions for the AMHS to move one or more products on which the plurality of tasks are to be performed and/or to move additional resources required by the group of machines to perform the plurality of tasks, so that the group of machines can operate in accordance with the schedule for the group of machines, and wherein the computer system is further configured to provide the schedule for the AMHS to the factory via the communication means.

41. The system of claim 27, wherein the group of machines comprises two or more different types of machine, wherein the machines in the group of machines are coupled together by at least one operational constraint such as a time link constraint, a maximum number of products which can be operated on by the group of machines, a Kanban process flow constraint and/or a high degree of re-entrancy of products moving between the machines.

42. The system of claim 27, wherein the communication means comprises one or more user interfaces in the factory for displaying the schedule for the group of machines and/or wherein the communication means comprises means to transmit control signals, wherein the control signals automatically operate the machines in the group of machines in accordance with the schedule and/or wherein the control signals automatically operate processes in the factory to enable the machines to operate in accordance with the schedule for the group of machines, and optionally wherein the system further comprises the group of machines.

43. The system of claim 27, wherein before using the first method to generate the schedule for the plurality of machines, the computer system is configured to perform a clustering step in which the group of machines is divided into subgroups of machines, and wherein the computer system is configured to generate the schedule for one or more of the subgroups of machines, and to provide the schedule for the one or more subgroups of machines to the factory via the communication means.

44. The system of claim 27, wherein using the second method to optimise the schedule generated by the first method comprises decomposing the tasks to be scheduled into chunks of tasks, wherein each chunk of tasks is individually optimised using the second method.

45. A method of providing a schedule for a group of machines, the method comprising generating the schedule for the group of machines by performing the steps of:
receiving a plurality of tasks to be performed by the group of machines;
using a first method to generate the schedule for the group of machines, comprising allocating one task of the plurality of tasks or a time-ordered list of some of the plurality of tasks to each machine of the group of machines; and
using a second method to optimise the schedule generated by the first method, and wherein the method further comprises providing the schedule for the group of machines to the group of machines in a factory.

46. A computer software product for installing on a factory computer system for providing a schedule to a group of machines in a factory, wherein the computer software product enables the factory computer system to operate using the method of claim 45.
